(19) United States
(12) Patent Application Publication
(10) Pub. No.: US 2008/0219622 A1
(43) Pub. Date: Sep. 11, 2008

(54) OPTICAL FIBRE COUPLING SYSTEM

(75) Inventor: Steffan Lewis, Reading (GB)

Correspondence Address: GAUTHIER & CONNORS, LLP, 225 FRANKLIN STREET, SUITE 2300, BOSTON, MA, 02110, US

(73) Assignee: GSI GROUP LTD., Rugby (GB)

(21) Appl. No.: 12/061,251

(22) Filed: Apr. 2, 2008

Related U.S. Application Data
(63) Continuation of application No. PCT/GB2006/050357, filed on Oct. 27, 2006.

(30) Foreign Application Priority Data
Oct. 29, 2005 (GB) 0522083.5

(51) Int. Cl. G02B 6/26; C03B 37/02

(52) U.S. Cl. 385/43; 65/435

(57) ABSTRACT

An optical fibre coupling structure comprising an optical fibre having an elongate input surface and shaped so that the diameter of the core of the fibre reduces in one dimension away from the input while increasing in the other dimension away from the input to form respective convergent and divergent surfaces, towards an output which is more circular than the input.

### PRIORITY

This application is a continuation application of and claims priority to PCT/GB2006/050357 filed Oct. 27, 2006, which claims priority to GB Application No. 0522083.5 filed on Oct. 29, 2005.

### BACKGROUND

This invention relates to an optical coupling system. In particular, but not exclusively, it relates to an optical fibre structure for coupling the output of a high-power semi-conductor having a linear emitting region into an optical fibre with high coupling efficiency and brightness.

High-power semi-conductor laser diodes are often used for pumping fibre lasers. In these applications, the output from the fibre laser is applied to a cladding layer of the fibre which has Bragg gratings formed in its core and the energy from the laser diodes is used as pumping energy to cause a lasing effect within the active fibre.

A means is therefore required for coupling the output of these high-power semi-conductor laser diodes into the cladding of the optical fibres.

High-power semi-conductor laser diodes suitable for such laser pumping often have linear emitting regions. Most commonly, these have dimensions of approximately 1×100 μm. The output of such an emitter can be coupled into a multi-mode optical fibre with a core diameter slightly larger than the emitter width, typically around 105 μm, using a simple fast axis collimation scheme. It is desirable to use emitters with larger output width, typically as large as 1,000 μm, as these can produce more power at a lower cost per watt. However, if the output of such lasers is coupled into a circular optical fibre using a straightforward fast axis collimation scheme, then the diameter of the optical fibre core must be very large (ie greater than 1000 g/m) and therefore the brightness (or more correctly radiance) of the fibre coupled output may be too low to be useful as a fibre laser pump source.

Various techniques have been developed for circularising the output of linear semi-conductor laser sources and coupling this into an optical fibre with much smaller diameter than the emitter width. U.S. Pat. No. 4,688,884 discloses a fibre optical coupling system for phased array semi-conductor lasers. This system is for coupling the output from an array of semi-conductor lasers to an optical fibre and has a ‘squashed’ input end which has a generally elliptical, cross-section. The output end is generally circular for coupling to a circular fibre.

The fibre coupler shown in this document however is squashed to produce its input end. Such squashing may cause difficulties during manufacture such as damage the coupler or may lead to unreliable or unquantifiable transmission rates or to non-repeatability amongst different couplers. The coupling efficiency with this coupler may be around 77 to 80% but is generally less than optimal for a given configuration.

There is a need, therefore, for an improved optical coupler and a further need to increase coupling efficiency.

### SUMMARY

The invention provides an optical fibre coupling structure comprising an optical fibre having an elongate input surface and shaped so that the diameter of the core of the fibre reduces in one dimension away from the input while increasing in the other dimension away from the input to form respective convergent and divergent surfaces, towards an output which is more circular than the input.

### BRIEF DESCRIPTION OF THE DRAWINGS

Embodiments of the invention will now be described, by way of example only, with reference to the accompanying drawings, in which:

FIG. 1 shows an optical coupler coupling between a single emitter laser and an output fibre;

FIG. 2 shows a first manufacturing step;

FIG. 3 shows a second manufacturing step;

FIG. 4 shows a vertical cross-section;

FIG. 5 shows a horizontal cross-section;

FIG. 6 is explanatory diagram;

FIG. 7 is a further explanatory diagram; and

FIG. 8 is a plot of coupling efficiency against taper length for cores of different configuration.

### DETAILED DESCRIPTION

According to the present invention there is provided an optical fibre coupling structure comprising an optical fibre having an elongate input surface and shaped so that the diameter of the core of the fibre reduces in one dimension away from the input while increasing in the other dimension away from the input to form respective convergent and divergent surfaces, towards an output which is more circular than the input.

Preferably, the structure comprises an optical fibre that tapers outward in a direction towards the input and has a wedge formed onto the tapered section.

The optical fibre most preferably has a core which is non-circular in cross-section so as to couple optical rays input at the input end between horizontal and vertical planes.

The invention further provides a method of forming an optical fibre coupling structure comprising tapering an optical fibre to a required output diameter and forming a wedge onto the tapered section by removal of material so as to form an elongate input at the end of the wedge portion.

In a further aspect, there is provided a method of coupling a laser beam into an output optical fibre, using a coupling structure.

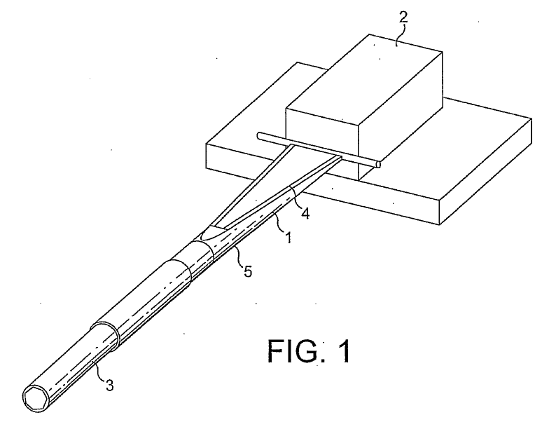

Referring now to FIG. 1, a coupling structure 1 is shown coupling between a broad stripe single laser emitter (eg laser diode emitter) 2 and an output optical fibre 3.

The laser emitter 2 is a broad stripe single emitter and typically is arranged to have an output aperture of about 750×1 μm. The laser diode may be used to provide pumping energy through a fibre 3 to a cladding pumped optical fibre laser 3. The coupling structure 1 is mounted between the laser diode 2 and output fibre 3. The structure 1 comprises a large diameter optical fibre that is tapered and has a low angle wedge 4 machined or polish onto the tapered section 5. As is shown in FIGS. 1 to 5, the fibre is tapered so that its diameter in one direction (the horizontal direction) is greatest at its input and reduces generally continuously along the tapered section 5. Similarly, the wedge section is formed so that the diameter in the other direction is at a minimum at the end 6 and diverges outwards away from the input along section 5. The input surface is therefore generally rectangular but may have other shapes provided it has one major dimension (the horizontal dimension in this case) which is substantially greater than the other major dimensions.

The optical fibre includes a central core 7 and at least one cladding layer 8. Optical radiation is transmitted within the fibre by virtue of total internal reflection at the core-cladding interface.

Radiation is emitted from the laser diode or other emitter 2 via a fast access collimator 9 into the input face 6 of the coupler. In the coupler, the generally rectangular or otherwise elongate output of the linear emitter is circularised and coupled into an output optical fibre 3 with core diameter smaller than the emitter width.

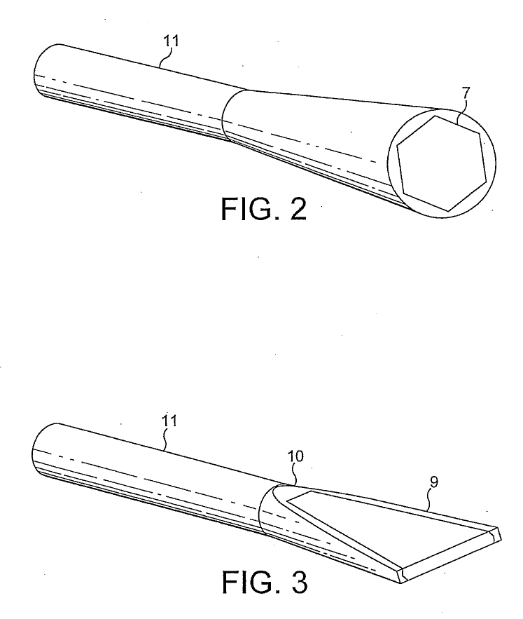

As is shown in FIG. 2, the coupler most preferably has a non-circular core. Advantageously, it is faceted and may be hexagonal as shown by the core 7 shown in FIG. 2 or may be another polygonal shape having flat sides or have other non-circular configurations. The reason for this will be described further below.

FIGS. 2 and 3 show the basic steps in manufacturing the coupler. Firstly, a relatively large diameter optical fibre (typically having a diameter which is to represent the largest diameter of input face 6 of the coupler after manufacture) is tapered by heating and drawing to the required output diameter. The fibre has a non-circular core. This step is shown in FIG. 2 where the fibre reduces in diameter from its input end 6 towards its output end. In one example, the input diameter may be about 800 μm and the output diameter about 400 μm.

Secondly, as shown in FIG. 3, a wedge 9 is formed on the tapered section. This is formed by an operation which removes material, such as a machining or planing operation.

It is preferably performed by optical polishing but may be performed by other methods. The wedge may be formed on one or both sides of the fibre.

The coupler may terminate at the largest diameter part 10 of the wedge portion or may continue, as shown in FIGS. 2 and 3, with a generally cylindrical optical fibre section 11 which can then be connected to an output fibre 3.

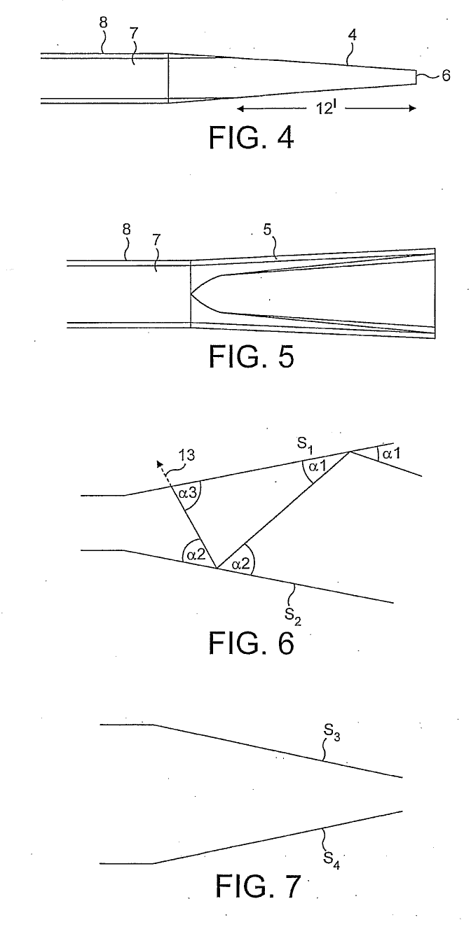

As shown in FIG. 3, and also more clearly in FIG. 4, the wedge is preferably formed so that it exposes the core 7 directly to the air at least the narrower end of the wedge shown by portion 12 in FIG. 4.

As is well-known, optical transmission in an optical fibre occurs by total internal reflection of light at the core/cladding interface provided at the incident angle of the radiation is less than the critical angle of that interface. In the portion of the coupler in which the core is exposed, the interface is a core-air interface and internal reflection also occurs at this interface provided the critical angle relevant to this interface is not exceeded.

Basically, the structure of the coupler is one in which the diameter of the fibre reduces in one dimension away from the input while increasing in the other dimension away from the input. Thus, the tapering causes a reduction in the horizontal dimension (in the disposition shown in the figures) whilst the wedging causes an increase in the vertical dimension, both in the direction away from the input.

As is shown in FIG. 6, an optical ray which is incident upon a first wall S1 of a convergent structure at an angle α₁ which is less than the critical angle is reflected off this surface at similar angle α₁. It then impinges upon opposite wall S2 but at an increased angle α₂. This angle might again be less than the critical angle so that ray is reflected back to surface S1. At surface S1 this time, because S1 and S2 are convergent, the angle of incidence will again be greater and this might be greater than the critical angle. Therefore, the ray is not internally reflected and may pass out of the fibre, as shown at 13.

To overcome this, if the coupler is divergent in the other dimension, as shown in FIG. 7, then provided the optical rays are caused to couple between, say, the horizontal and vertical planes, then rays alternately reflecting from the top and side surfaces will alternately encounter converging and diverging surfaces. Thus, the effect, outlined with respect to FIG. 6, will be cancelled out if after each time a ray contacts one of the (convergent) surfaces S1 or S2 it then contacts one of the (divergent) surfaces S3 and S4. This ensures that any ray input at the correct angle to the input face 6 of the coupler will continue to transmit through the fibre to the output 10 and hence onwards through the rest of the fibre.

Instead of the term “critical angle” the term “numeral aperture” is often used in relation to optical fibres so that if an incident angle exceeds the numeral aperture of the optical fibre it ceases to be guided by it and is transmitted outwards through the side of the fibre, as shown at 13.

The optical fibre is caused to have a core which is non-circular to provide better coupling between the convergent and divergent surfaces of FIGS. 6 and 7, for example. If the core were circular, any light ray which enters in a horizontal disposition for example would simply be reflected horizontally each time and therefore would ultimately probably cease to be transmitted, as described above. If this ray on the other hand encounters a surface which is not perpendicular to its direction of travel then the ray will be reflected at a non-horizontal angle and thus will ultimately impinge upon both generally divergent and generally convergent surfaces, thus ensuring that the ray continues to be transmitted.

A hexagonal core geometry, as shown in FIG. 2, has been found to be particularly efficient in this regard but any other core geometry which is non-circular may also be used. The geometry is preferably a faceted one comprising a polygonal shape with three of more straight sides. It may be, for example, pentagonal, hexagonal or any other polygonal shape. Alternatively, one or more of the surfaces of the core may be arcuate or any other non-circular configuration may be used for different configurations.

Effectively, the hexagonal or other non-circular orientation increases the coupling of rays between the horizontal and vertical plane and thus increases performance. This can enable the length of the taper to be reduced, making the structure easier to manufacture.

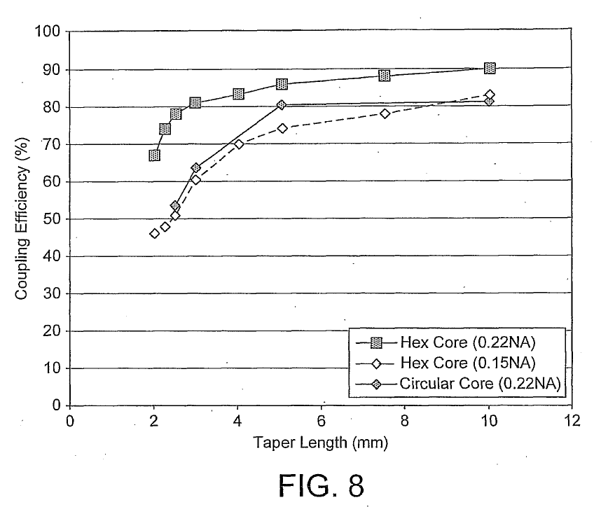

FIG. 8 shows a plot of taper length in millimetres (ie length of the wedge portion) against coupling efficiency calculated for three different samples. These are respectively for a hexagonal core of numerical aperture 0.22, a hexagonal core of numerical aperture 0.15 and for a circular core of numerical aperture 0.22. The emitter dimensions are 750×1 μm. The input core width is 800 μm wide and the output optical fibre core diameter is 400 μm.

The results show that in general a longer taper length results in higher coupling efficiency. However, a longer tapered section can be more difficult to manufacture and it is therefore desirable to minimise the length of the tapered section. In the example shown, the highest coupling efficiency is seen to be around 90% and this is achieved for a 10 mm taper with a hexagonal core numerical aperture of 0.22. The results show that to obtain the highest coupling efficiency, a hexagonal or other faceted or non-circular core is preferable to a circular section core. A circular core geometry gives lower coupling efficiency as there is insufficient coupling between rays in the horizontal and vertical planes.

Some of these surfaces may have anti-reflection coatings and this would result in even higher coupling efficiency.

1. An optical fibre coupling structure comprising an optical fibre having an elongate input surface and shaped so that the diameter of the core of the fibre reduces in one dimension away from the input while increasing in the other dimension away from the input to form respective convergent and divergent surfaces, towards an output which is more circular than the input.

2. A coupling structure as claimed in claim 1, comprising an optical fibre that tapers outward in a direction towards the input and has a wedge formed onto the tapered section.

3. A structure as claimed in claim 1, wherein the optical fibre has a core which is faceted.

4. A structure as claimed in claim 3, wherein the core is of hexagonal section.

5. A structure as claimed in claim 1, wherein the optical fibre has a core which is of non-circular section and is shaped so as to couple optical ray input at the input end between converging and diverging surfaces of the coupler.

6. An optical fibre coupling structure as claimed in claim 5, wherein the core is shaped so as to induce vertical displacement so that any optical ray entering the input is caused to impinge upon the top or bottom surface of the core before that ray reaches the end of a tapered section forming part of the coupling structure.

7. A method of forming an optical fibre coupling structure comprising tapering an optical fibre to a required output diameter and forming a wedge onto the tapered section by removal of material so as to form an elongate input at the end of the wedge portion.

8. A method as claimed in claim 7, wherein the optical fibre is tapered by heating and drawing.

9. A method as claimed in claim 7, wherein the wedge is formed by machining, preferably optical polishing, onto the tapered section.

10. A method as claimed in claim 7, wherein the optical fibre has a non-circular core.

11. A method as claimed in claim 10, wherein the core has a faceted cross-section.

12. A method as claimed in claim 7, wherein the wedge is formed to include a portion in which the core of the optical fibre is exposed.

13. A method of coupling a laser beam into an output optical fibre, comprising using a coupling structure as claimed in claim 1.

14. A method as claimed in claim 13, wherein the laser beam is a single beam.

15. A method as claimed in claim 13, wherein the laser beam is the output of a laser diode.

16. A method as claimed in claim 13, wherein the laser beam is a pumping beam.

17. (canceled)

18. (canceled)
